(19) United States
(12) Patent Application Publication
(10) Pub. No.: US 2026/0098553 A1
(43) Pub. Date: Apr. 9, 2026

(54) CLIP FOR SECURING A PHOTOVOLTAIC PANEL TO A FIXTURE, AND AN ASSEMBLY INCLUDING THE CLIP

(71) Applicant: A. RAYMOND ET CIE, Grenoble (FR)

(72) Inventors: Christian FRIEDRICH, Rochester Hills, MI (US); Chris FRANKLIN, Rochester Hills, MI (US)

(21) Appl. No.: 19/112,771

(22) PCT Filed: Sep. 20, 2022
(86) PCT No.: PCT/IB2022/058884

§ 371 Date: Mar. 18, 2025

(51) Int. Cl. F16B 2/24; H02S 20/20

(52) U.S. Cl. CPC F16B 2/243; H02S 20/20

(57) ABSTRACT

A clip (20) for securing a photovoltaic panel to a fixture is provided. The clip (10) includes a central portion (12) having a pair of opposite lateral ends (14, 15) and opposite front and back longitudinal ends (16, 17). A pair of side walls (18) extends from the lateral ends (14, 15) of the central portion (12). A longitudinally extending jaw (26) is formed in each of the side walls (18). Each jaw (26) defines a C-shaped slot (28). A terminal portion (34) extends outwardly from each of the side walls (18). At least one engagement member (38) extends from each of the terminal portions (34). The central portion (12) and the side walls (18) together have an open cross-section, and the clip (10) is compressible and expandable in a lateral direction.

### FIELD OF THE INVENTION

The disclosure generally relates to a clip for holding two flat elements and, more specifically, to a clip used to secure a photovoltaic panel to a fixture.

### BACKGROUND OF THE INVENTION

It is known to utilize metal clips to hold flat elements assembled in contact with one another at faces thereof, such as assembling a frame of a photovoltaic panel to a fixture such as a rail of a supporting frame. Photovoltaic (e.g. solar) panels may be arranged on a fixture having a single axis that rotates to track the movement of the sun across the sky. Such an arrangement of solar panels are subjected to wind updraft loads, downforce loads, and sliding loads. Recently, solar panels used in these tracking arrangements have been made to have larger surface area, which increases the magnitude of the loads that are applied to the solar panels and the corresponding fixture. Therefore, clips used to mount solar panels onto a rotating fixture should be able to withstand these loads.

### BRIEF SUMMARY

A clip for securing a photovoltaic panel to a fixture is provided. The clip includes a central portion having a pair of opposite lateral ends and opposite front and back longitudinal ends. A pair of side walls extends from the lateral ends of the central portion. A longitudinally extending jaw is formed in each of the side walls. Each jaw defines a C-shaped slot. A terminal portion extends outwardly from each of the side walls. At least one engagement member extends from each of the terminal portions. The central portion and the side walls together have an open cross-section, and the clip is compressible and expandable in a lateral direction.

In specific embodiments, two engagement members extend from each of the terminal portions.

In particular embodiments, the engagement members are one of cantilever springs and teeth.

In specific embodiments, the clip includes a first bend between the central portion and each side wall.

In specific embodiments, the clip includes a second bend between each side wall and each terminal portion.

In specific embodiments, the central portion includes one of a planar surface and a curved surface.

In specific embodiments, each jaw includes at least one tooth projecting into the C-shaped slot defined by the jaw.

In certain embodiments, the clip includes a tongue projecting diagonally from the central portion.

In certain embodiments, each side wall includes a slot proximate the central portion and an inwardly facing projection proximate the terminal portion.

In certain embodiments, the terminal portion includes a wing extending laterally relative to the side wall and generally coplanar with the central portion.

In certain embodiments, each jaw includes an outwardly extending reinforcement flange around a perimeter of the C-shaped slot.

In certain embodiments, each side wall includes a vertically extending reinforcement rib adjacent the jaw.

In certain embodiments, each jaw includes a hook adjacent an open end of the C-shaped slot.

In certain embodiments, the central portion includes a pair of C-shaped slots aligned with the C-shaped slots defined by the jaws.

In certain embodiments, the central portion and the side walls define a U-shaped channel.

In certain embodiments, the central portion and the side walls together have a W-shaped cross-section.

In specific embodiments, the clip is one or more of: (i) electrically conductive; (ii) metallic; (iii) formed from a single bent sheet of metal; and (iv) monolithic in construction.

An arrangement including a plurality of the clips is also disclosed. The plurality of clips are stackable one on top of the other.

In specific embodiments, the plurality of clips are stackable such that the inwardly facing projections of one of the clips snaps into the slots of another, adjacent one of the clips.

An assembly is also disclosed. The assembly includes a clip according to the disclosure, a first flat element, and a second flat element. The first flat element and the second flat element are arranged and held together at faces thereof in the jaws in the clip.

### DESCRIPTION OF THE DRAWINGS

Various advantages and aspects of this disclosure may be understood in view of the following detailed description when considered in connection with the accompanying drawings, wherein:

FIG. 1 is a front view of a clip in accordance with some embodiments of the disclosure;

FIG. 2 is a perspective view of the clip of FIG. 1 from above;

FIG. 3 is a perspective view of the clip of FIG. 1 from below;

FIG. 4 is a rear perspective view of the clip of FIG. 1;

FIG. 5 is a side perspective view of the clip of FIG. 1;

FIG. 6 is a perspective view of a stack of the clips of FIG. 1;

FIG. 7 is a front view of a clip in accordance with other embodiments of the disclosure;

FIG. 8 is a perspective view of the clip of FIG. 7 from above;

FIG. 9 is a perspective view of the clip of FIG. 7 from below;

FIG. 10 is a rear perspective view of the clip of FIG. 7; and

FIG. 11 is a perspective view of an assembly implementing a clip in accordance with the disclosure.

### DETAILED DESCRIPTION OF THE INVENTION

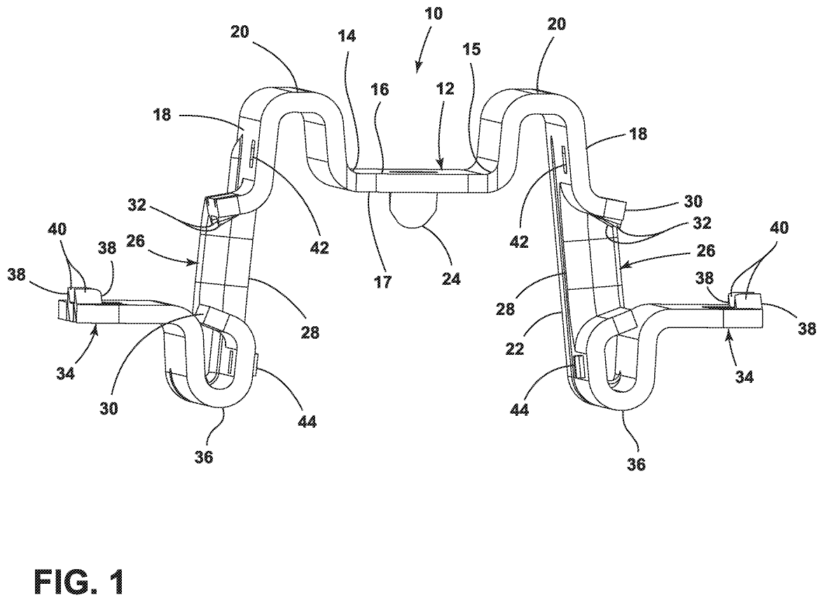

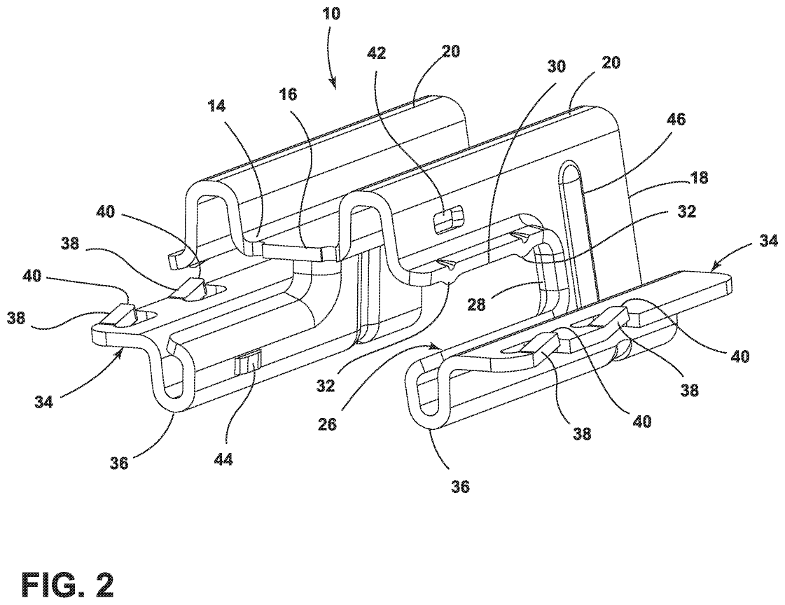

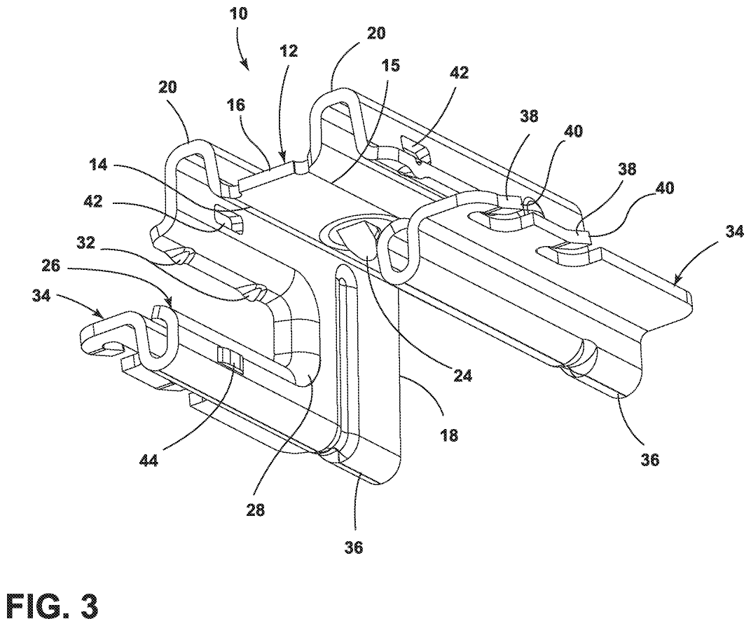

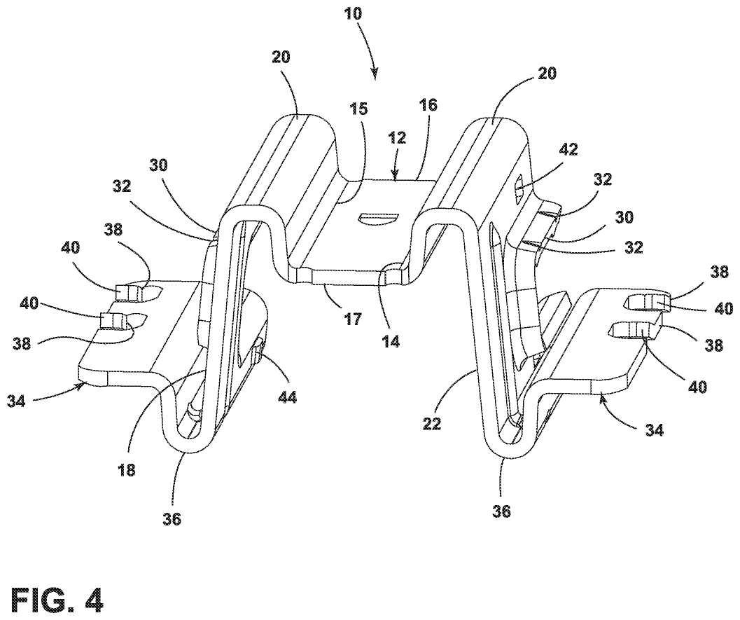

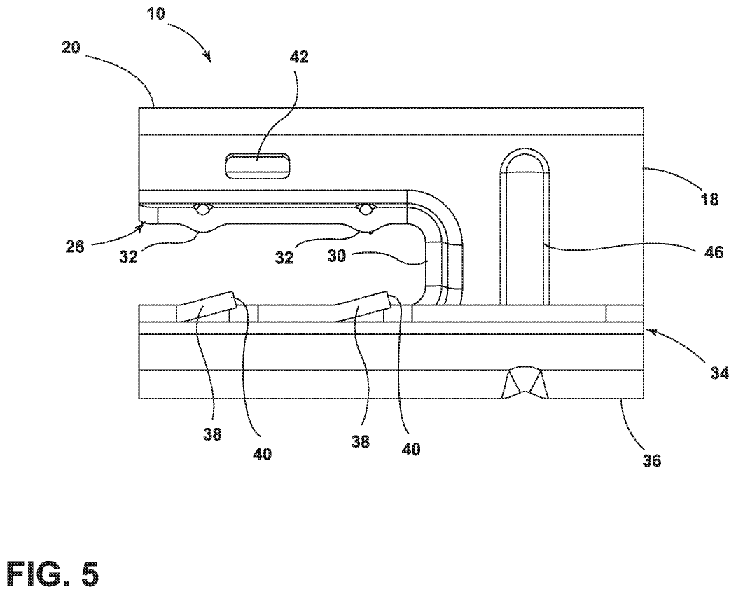

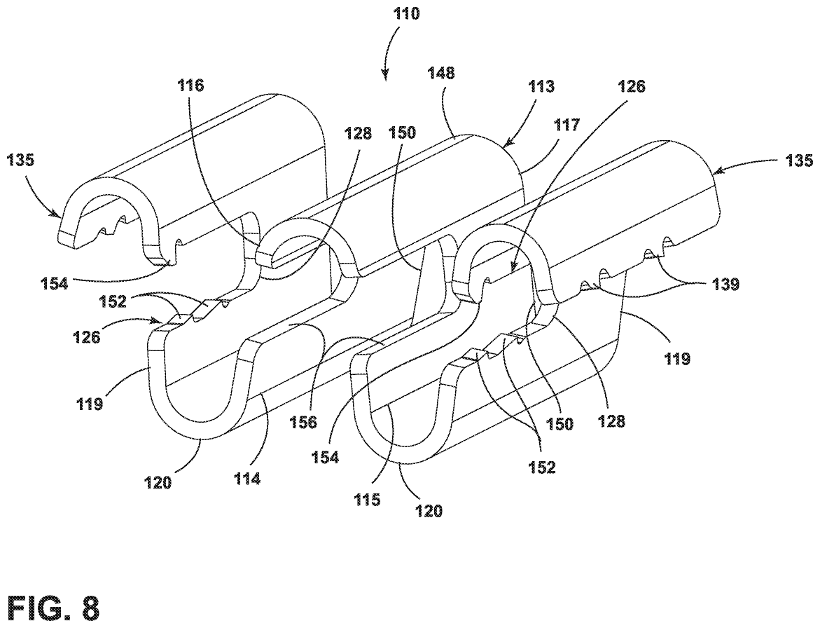

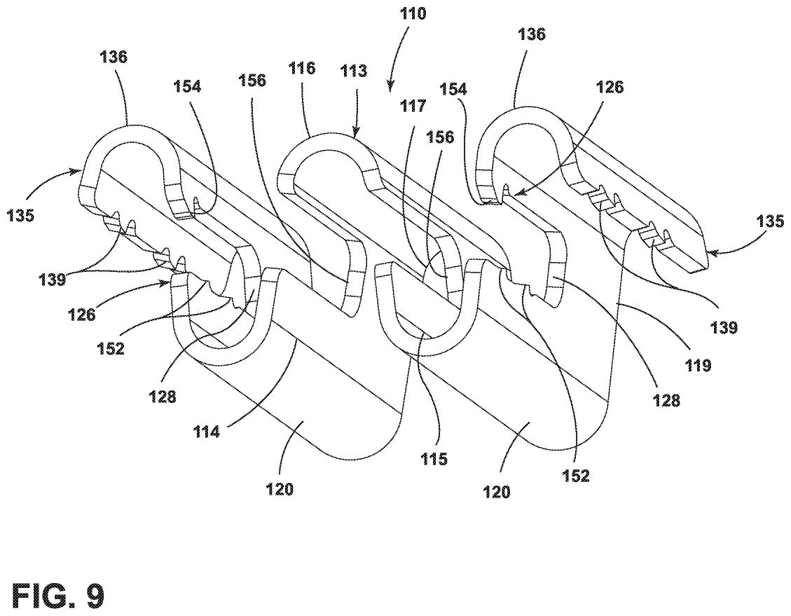

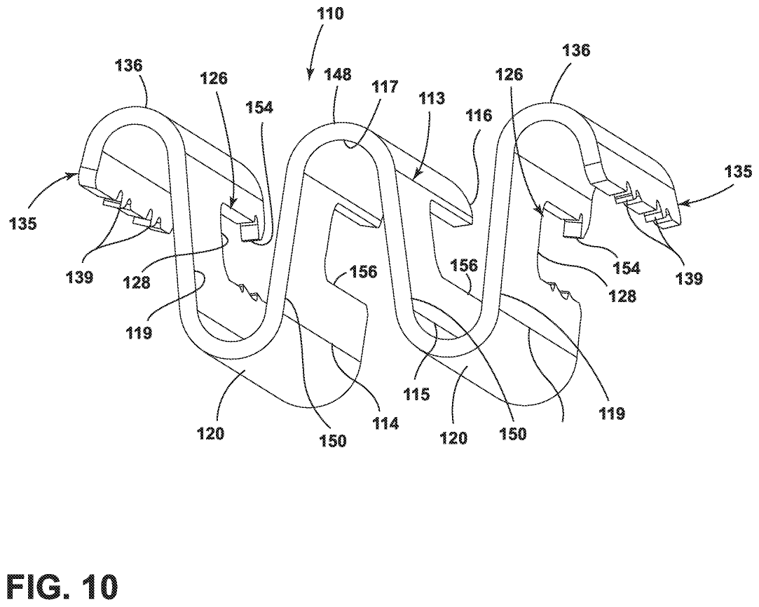

A clip for securing a photovoltaic panel to a fixture is provided. Referring to FIGS. 1-11, wherein like numerals indicate corresponding parts throughout the several views, the clip is illustrated and generally designated at 10. Certain features of the clip 10 are functional, but can be implemented in different aesthetic configurations. The clips according to different embodiments of the disclosure are formed to have an open cross-section, that is to say, when viewed from the front or rear, the shape of the clip has at least one open side and does not form an enclosed box-shape. As described in more detail below, the open cross-section allows the clip to be compressible and expandable in a lateral direction.

Turning to FIGS. 1-6, in a first illustrative embodiment the clip 10 includes a central portion 12. The central portion 12 has a pair of opposite lateral ends 14, 15 and also a pair of opposite front and back (rear) ends 16, 17, respectively, wherein a lateral direction extends along a line running through and perpendicular to the lateral ends and a longitudinal direction extends along a line running through and perpendicular to the front and back ends. In this embodiment, the central portion 12 is generally a flat, planar portion that has a parallelogram shape (preferably rectangular) and that has a length and width much greater than its thickness. A side wall 18 extends from each of the two lateral ends 14, 15 of the central portion 12. Particularly, a first bend 20 is formed between the central portion 12 and each side wall 18, and the first bend interconnects the central portion and side wall. The central portion 12 and the side walls 18 define a U-shaped channel 22 within the boundaries of the clip 10, and a cross-section of the clip taken along a line extending from one lateral end 14 to the other lateral end 15 generally has a U-shape. The clip 10 is therefore open along the bottom between the two lateral side walls 18 opposite the central portion 12. An angle between the central portion 12 and each side wall 18 is slightly obtuse such that the distance between the side walls is greater at the open end of the U-shaped channel than at the ends of the side walls that are connected to the central portion 12. The clip 10 is also generally symmetrical about a plane that runs through the center of the central portion 12 from the front end 16 to the back end 17, such that one side wall 18 is generally a mirror image of the other, and the features of each side wall are generally the same. A tongue 24 in the form of a small tab or rounded projection extends diagonally and downwardly from the central portion 12 and inwardly into the U-shaped channel 22 between the two side walls 18.

A longitudinally extending jaw 26 is formed in each of the side walls 18. Each jaw 26 defines a C-shaped slot 28 that is open towards the front end 16 of the central portion 12 and extends partially (e.g, approximately halfway or slightly more than halfway, i.e. between 50% and 70% of the way) towards the back end 17. The C-shaped slot 28 is generally longer in a direction from front 16 to back 17 than it is high in a direction from the central portion 12 down the lateral side wall 18. The jaw 26 includes an outwardly extending reinforcement flange 30 around a perimeter of the C-shaped slot 28, the reinforcement flange extending outwardly in a direction away from the U-shaped channel 22 and particularly away from the inner surface of the side wall 18. The reinforcement flange 30 strengthens the C-shaped slot 28 and allows for higher loads to be exerted on the C-shaped slot during use of the clip 10 as described in more detail below, and thereby prevents against brittle failure. As shown, the reinforcement flange 30 extends at an acute angle relative to the inner surface of the side walls 18, but the angle of the reinforcement flange relative to the side walls is not particularly limited. At least one, preferably two, teeth in the form of a dimple 32 project from the top of the reinforcement flange 30 (a portion of the reinforcement flange proximate the central portion 12 of the clip 10) into the C-shaped slot 28 of the jaw 26. While the C-shaped slot 28 of each side wall 18 preferably includes two dimples 32 for reasons that will be more apparent below, only one dimple is required, and in some embodiments one of the C-shaped slots may include two dimples while the other may include only one.

A terminal portion 34 extends in an outward direction away from each of the side walls 18. Particularly, a second bend 36 is formed between each side wall 18 and terminal portion 34, and the second bend interconnects the side wall and terminal portion. In the embodiment shown in FIGS. 1-5, the terminal portion 34 is a wing that extends laterally from and nearly perpendicular relative to the side wall 18, extending mostly outwardly, at a slight angle relative to a normal line extending from the side wall, and generally parallel to a plane in which the central portion 12 lies. At least one, preferably two, engagement members 38 extend from each of the terminal portions 34. In this embodiment, the engagement members 38 are cantilever springs that are flat strips or tabs that extend upwardly and at an acute angle relative to an upper surface of the terminal portions 34. Preferably, a tip (terminal edge) 40 of each engagement member 38 is vertically aligned with a corresponding dimple 32 formed in the C-shaped slot 28 such that each tip is the same distance from the front and back ends 16, 17 of the central portion 12 as its corresponding dimple in a horizontal direction. However, the engagement members 38 may be spaced farther apart from each other than the dimples 32, but at the same time should be no farther towards the back end 17 of the central portion 12 than the closed, back end of the C-shaped slot 28.

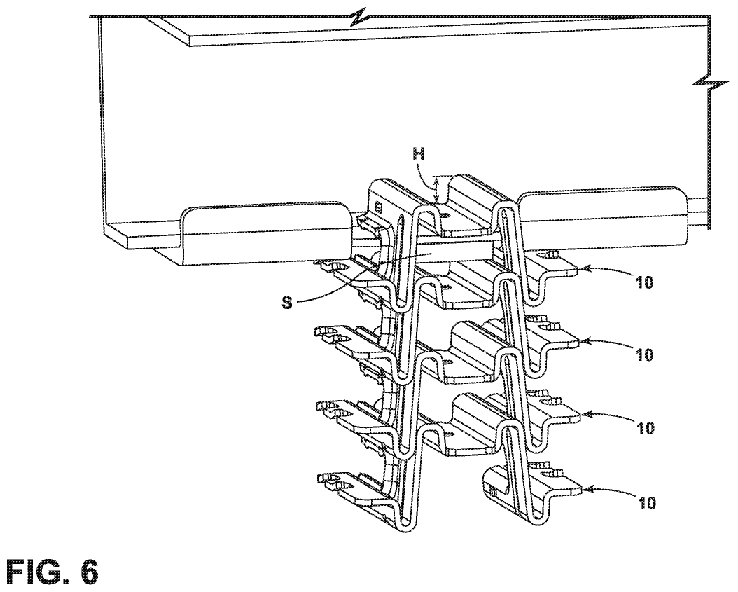

Each side wall 18 includes a slot 42 that is proximate the central portion 12 of the clip 10. The slot 42 may be a generally rectangular opening that is disposed between the jaw 26 and first bend 20, and towards the front end 16 of the central portion 12. Each side wall 18 additionally includes an inwardly facing projection 44 in such as a bump, raised surface, button, or similar proximate the terminal portion 34 of the clip 10 and disposed between the jaw 26 and the second bend 36. The projection 44 may have a generally rectangular perimeter that corresponds in size and shape to the opening defined by the slot 42. Further, the projection 44 is vertically aligned with the slot 42 such that the projection and slot are the same distance between the front and back ends 16, 17, i.e. they are both the same distance from the front end 16 as well as the same distance from the back end 17 in a horizontal direction. A plurality of the clips 10 are stackable one on top of another as shown in FIG. 6, and the alignment of the projections 44 and slots 42 is significant because when one clip 10 is stacked on top of another clip 10, the projections 44 on the upper of the two clips interface with and snap into the slots 42 on the adjacent, lower of the two clips in order to hold the clips securely together. A slight pulling force on the side wall 18 in an outward direction removes the projection 44 from the slot 42 and allows the two clips to be separated from each other.

Each side wall 18 also includes a vertically extending reinforcement rib 46 or boss adjacent the jaw 26 and proximate the back end 17 of the central portion 12. The reinforcement ribs 46 are generally perpendicular to the lateral ends 14, 15 of the central portion 12 and extend in a line from a location adjacent the central portion 12 to a location adjacent the terminal portion 34. The reinforcement ribs 46 increase the strength of the clip 10 and prevent against brittle failure of the clip. Particularly, the reinforcement ribs 46 stiffen the clip 10 with respect to shear forces and residual moments of torsion to which the clip could be subjected.

The C-shaped slots 28 in each side wall 18 are arranged at generally the same distance from the central portion 12 and are configured to allow the clip 10 to be introduced from its front end 16 on two flat elements (such as a photovoltaic rail (for solar panels) and tracker hanger (constituting a fixture)) that are joined to one another by their main faces in order to hold the two elements against height other. Since the clip 10 has an open cross-section, the clip may be compressed during installation onto the two elements, which expands the height of the clip and eases installation. Once installed, if the clip 10 experiences side loads, it may expand its width by elastic deformation, which constricts the height of the clip and increases the amount of force the clip exerts on the two elements. Further, the surface area of the central portion 12 that spans the length of the middle of the clip disperses high upload drafts over the area of the central portion and reduces the forces exerted on the other portions of the clip. The reinforcement flange 30 of the C-shaped slots 28 reinforces the clip 10 against loads exerted on the clip when the two elements are inserted into the C-shaped slots, which forces may be higher due to the open cross-section of the clip (i.e., no closed wall on the bottom side of the clip). The dimples 32 in the C-shaped slots 28 bite into the surface of one of the two elements and prevent against twisting action that may occur between the clip and the two elements received in the C-shaped slots. The dimples 32 also aide in the electrical connection between the clip 10 and the two elements. The electrical connection also may be provided by the tongue 24, which extends downwardly to a position that is lower than the top of the C-shaped slots 28, whereby the tongue contacts a surface of one of the two elements received in the C-shaped slots. The engagement members 38 on the terminal portions 34 act as springs that increase the force exerted by the clip 10 and in turn the contact between the clip and the two elements received in the C-shaped slots 26. The engagement members 38 are also aligned with the dimples 32 from front to back so that the force exerted by the engagement members increases the force of contact between the dimples and the one of the two elements of the assembly that the dimples touch.

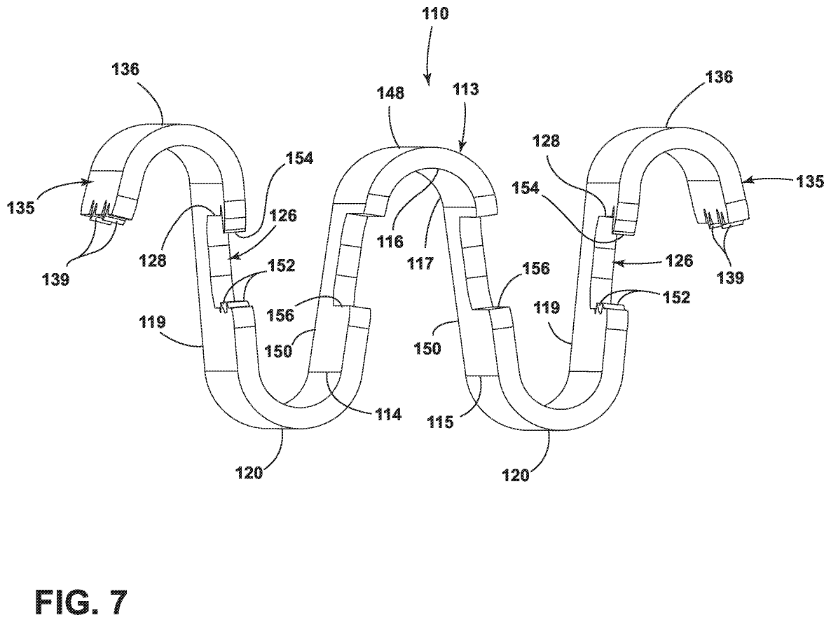

Turning next to FIGS. 7-10, in a second, alternative and illustrative embodiment the clip 110 includes a central portion 113, a pair of side walls 119, and a terminal portion 135 extending outwardly and downwardly from each of the side walls. The central portion 113 has a pair of opposite lateral ends 114, 115 and also a pair of opposite front and back ends 116, 117, respectively. In this embodiment, the central portion 113 is generally an angled section having a curved surface at its apex 148 between two intermediate sides 150 that form an acute angle with the apex. The side walls 119 extend from each of the two lateral ends 114, 115 of the central portion 113, and a first bend 120 is formed between the central portion 113 and each side wall 119. The first bend 120 interconnects the central portion 113 and side walls 119 and forms an acute angle between the central portion and side wall. The terminal portion 135 extends from each of the side walls 119, a second bend 136 is formed between each side wall 119 and terminal portion 135. The second bend 136 interconnects the side wall 119 and the corresponding terminal portion 135, and forms an acute angle between each side wall and corresponding terminal portion. The central portion 113 and the side walls 119 have a W-shaped cross-section. The clip 110 is therefore open along the bottom between the two sides 150 of the central portion 113, as well as open along the top between the central portion and each of the two laterally disposed side walls 119. The clip 110 is also generally symmetrical about a plane that runs through the center of the central portion 113 from the front end 116 to the back end 117, such that one side wall 119 is generally a mirror image of the other, and the features of each side wall are generally the same.

A longitudinally extending jaw 126 is formed in each of the side walls 119. Each jaw 126 defines a C-shaped slot 128 that is open towards the front end 116 of the central portion 113 and extends partially (e. g, approximately halfway or slightly more than halfway, i.e. between 50% and 70% of the way) towards the back end 117. The C-shaped slot 128 is generally longer in a direction from front to back than it is high in a direction from the central portion 113 down the lateral side wall 119. At least one, preferably two, teeth in the form of an angled, pointed projection 152 extend from a perimeter of the C-shaped slot 128 and into the C-shaped slot of the jaw 126. While the C-shaped slot 128 of each side wall 119 preferably includes two pointed projections, only one pointed projection is required, and in some embodiments one of the C-shaped slots 128 may include two pointed projections while the other may include only one. In this embodiment of the clip 110, each jaw 126 further includes a hook 154 adjacent an open end of the C-shaped slot 128. The hooks 154 are larger than the pointed projections 152 and are formed to interact with holes in a fixture (e.g. a solar tracker) to hold a solar panel at a predetermined position.

In the embodiment shown in FIGS. 7-10, the terminal portion 135 is a short (shorter than the side walls 119) outer wall that extends at a downward angle away from the side walls 119, i.e. mostly downward but slightly outward. At least one, preferably two, engagement members 139 extend from each of the terminal portions 135. In this embodiment, the engagement members 139 are additional teeth spaced a farther distance apart than the pointed projections 152 of the jaw 126. The engagement members 139 of the terminal portions 135 also may face an opposite direction than the pointed projections 152 of the jaw 126. For example, the engagement members 139 of the terminal portions 135 may face towards the back end 117 of the central portion 113, while the pointed projections 152 of the jaw 126 may face towards the front end 116. The engagement members 139 of the terminal portions 135 are generally disposed more towards the front end 116 of the central portion 113, but at least one of the engagement members may be disposed behind the end of the C-shaped slot 128.

In this embodiment, the central portion 113 further includes a pair of C-shaped slots 156 aligned with the C-shaped slots 128 defined by the jaws 126. Particularly, one C-shaped slot 156 is formed in each of the intermediate sides 150 of the central portion 113. The C-shaped slots 156 in the central portion are generally the same size and shape as the C-shaped slots 128 in the side walls 119. However, the C-shaped slots 156 do not include any projections, engagement members, teeth, or other surface feature.

A plurality of the clips 110 are stackable one on top of another. However, in this embodiment the clips 110 do not include any locking feature. Instead, due to the wavy W-shape of the clips 110, one clip may be simply stacked on top of another such that the valleys of one clip fit between the crests of an adjacent clip.

In use, the clip 110 functions similar to the clip 10. The open cross-section of the clip 110 allows for elastic deformation of the clip, whereby the clip may be compressed for installation on an assembly of flat surfaces (e.g., of a photovoltaic rail and tracker hanger) for ease of insertion of the C-shaped slots 128 onto the assembly, and may be expanded during exertion of side loads on the clip to provide an increased compressive force on the assembly. The wavey construction of the clip 110 increases its lateral strength, and due to the wavey construction, the central portion 113 also includes the C-shaped slots 156 at its front end 116 so that the assembly may inserted into all of the C-shaped slots 128, 156 at the front end of the clip 110. The pointed projections 152 and engagement members 139 hold the clip 110 in engagement with the assembly, act against sliding forces exerted on the clip, and aide in the electrical connection of the clip 110 to the assembly.

The clips 10, 110 are preferably formed of a metal such as but not limited to steel, stainless steel, and aluminum, or a metal alloy. As such, the clips 10, 110 may be electrically conductive. Further, the clips may be monolithic in construction, and specifically may be formed from a single bent sheet of metal. Particularly, the clips may be obtained by cutting and bending a metal strip at certain angles to form the portions of the clips. Any other bends, grooves, tabs, bosses, cutouts, or other deformations can be formed before the bending of the metal strip, for example, by cutting-stamping techniques. The manufacture of the clip can also include heat or wet treatments. The clip may have a length from front to back of approximately 20 to 40 mm, a height from bottom to top of approximately 15 to 30 mm, and a thickness (of the sheet forming the clip) in the range of approximately 2 to 5 mm. The C-shaped slot may have a depth (length) from its opening to its closed end of approximately 15 to 25 mm.

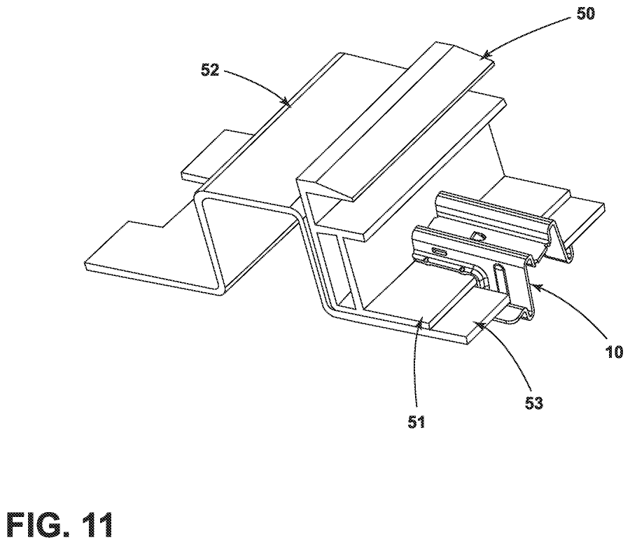

With reference now to FIGS. 1 and 11, an example of the use of the clip 10 is shown. A photovoltaic panel frame 50 is placed on a rail 52 of a supporting frame or other fixture. The frame 50 includes a portion 51 forming a first flat element and the rail 52 includes a portion 53 forming a second flat element. The portion 51 forming the first flat element has a face surface that rests on an adjacent face surface of the portion 53 forming the second flat element. The clip 10 is inserted on the two flat elements 51, 53. In this arrangement, the two flat elements are received and held in the jaws 26 of the clip, with the lower element 53 of the two elements contacting the engagement members 38 on the terminal portion 34 of the clip and the upper element 51 of the two elements contacting the dimples 32 and the tongue 24. Further, as shown in FIG. 6, the height of the first bend 20 relative to the central portion 12 provides an advantageous effect during installation of the clip 10. During installation, a plurality of the clips 10 may be stacked together as described above, whereby adjacent clips are held together via the engagement between the inwardly facing projections 44 of one clip and the slots 42 of the adjacent clip. Once the jaw 26 of the top clip 10 engages a substrate S such as the flat elements of a panel frame and a supporting fixture, the top surfaces of the first bends 20 of the clip in the stack directly below the clip engaging the substrate contacts the bottom of the substrate thereby providing a downward (awayward) force that disengages the inwardly facing projection 44 of the top clip (with jaws on the substrate) from the slots 42 of the adjacent clip directly below. In this manner, each clip from a stack of clips 10 may be quickly and easily dispensed during installation.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

1. A clip for securing a photovoltaic panel to a fixture, the clip comprising:
a central portion having a pair of opposite lateral ends and opposite front and back longitudinal ends;
a pair of side walls extending from the lateral ends of the central portion;
a longitudinally extending jaw formed in each of the side walls, each jaw defining a C-shaped slot;
a terminal portion extending outwardly from each of the side walls, and
at least one engagement member extending from each of the terminal portions;
wherein the central portion and the side walls together have an open cross-section, and the clip is compressible and expandable in a lateral direction.

2. The clip according to claim 1, including two engagement members extending from each of the terminal portions.

3. The clip according to claim 2, wherein the engagement members are one of cantilever springs and teeth.

4. The clip according to claim 1, including a first bend between the central portion and each side wall.

5. The clip according to claim 1, including a second bend between each side wall and each terminal portion.

6. The clip according to claim 1, wherein the central portion includes one of a planar surface and a curved surface.

7. The clip according to claim 1, wherein each jaw includes at least one tooth projecting into the C-shaped slot defined by the jaw.

8. The clip according to claim 1, including a tongue projecting diagonally from the central portion.

9. The clip according to claim 1, wherein each side wall includes a slot proximate the central portion and an inwardly facing projection proximate the terminal portion.

10. The clip according to claim 1, wherein the terminal portion includes a wing extending laterally relative to the side wall and generally coplanar with the central portion.

11. The clip according to claim 1, wherein each jaw includes an outwardly extending reinforcement flange around a perimeter of the C-shaped slot.

12. The clip according to claim 1, wherein each side wall includes a vertically extending reinforcement rib adjacent the jaw.

13. The clip according to claim 1, wherein each jaw includes a hook adjacent an open end of the C-shaped slot.

14. The clip according to claim 1, wherein the central portion includes a pair of C-shaped slots aligned with the C-shaped slots defined by the jaws.

15. The clip according to claim 1, wherein the central portion and the side walls define a U-shaped channel.

16. The clip according to claim 1, wherein the central portion and the side walls together have a W-shaped cross-section.

17. The clip according to claim 1, wherein the clip is one or more of: (i) electrically conductive; (ii) metallic; (iii) formed from a single bent sheet of metal; and (iv) monolithic in construction.

18. An arrangement including a plurality of the clips according to claim 1, wherein the plurality of clips are stackable one on top of the other.

19. An arrangement including a plurality of the clips according to claim 9, wherein the plurality of clips are stackable such that the inwardly facing projections of one said clip snap into the slots of another, adjacent one of said clips.

20. An assembly, comprising:
a clip according to claim 1;
a first flat element; and
a second flat element;
wherein the first flat element and the second flat element are arranged and held together at faces thereof in the jaws in the clip.
